(19) United States
(12) Patent Application Publication
(10) Pub. No.: US 2016/0247485 A1
(43) Pub. Date: Aug. 25, 2016

(54) Diagnostic Measuring Tools and Methods

(71) Applicant: Thomas James Bryce, Chestnut Ridge, NY (US)

(72) Inventor: Thomas James Bryce, Chestnut Ridge, NY (US)

(21) Appl. No.: 15/046,113

(22) Filed: Feb. 17, 2016

Related U.S. Application Data
(63) Continuation of application No. 62/117,183, filed on Feb. 17, 2015.

(51) Int. Cl. G09G 5/14; G06T 3/40; G06T 7/00; G06T 11/60

(52) U.S. Cl. CPC G09G 5/14; G06T 11/60; G06T 3/40; G06T 7/0012; G09G 2340/12; G09G 2340/04; G06T 2210/41

(57) ABSTRACT

A system for reviewing diagnostic images includes a processor; a storage device capable of storing image data connected to the processor; and an output device connected to the processor. The system operates upon a medical image stored in the storage device; the processor processes the image and displays a view of the image via the output device, adding a grid of markers displayed on the view of the image at regular intervals. A method of viewing medical images includes the steps of providing a system as described above, storing one or more medical images in the storage device, and using the system to display each medical image with a grid of markers displayed on the image at regular intervals. Preferably the system or method may be used on several medical images in succession, and may display four or another number of views of a medical image simultaneously.

### BACKGROUND OF THE INVENTION

In medical diagnostic imaging, interpreters of examinations use electronic measuring tools, which may be displayed as an overlay upon a diagnostic image, in order to measure various features shown on the diagnostic image.

Great efforts are expended by individual study interpreters to measure features appearing in diagnostic images. Where the images are displayed electronically, the interpreters, typically radiologists, undertake a very slow and laborious process requiring many mouse clicks to select the relevant portions of the displayed features. For this reason, the work of measuring features may consume much time and energy for the interpreters. Alternatively, the interpreters may estimate the sizes of features, thus causing decreased accuracy.

### DESCRIPTION OF THE INVENTION

Applicants have invented measuring tools to aid the interpreters in conveniently taking accurate measurements from diagnostic images. The measuring tools comprise a computer system that displays, upon a diagnostic image, a plurality of grids with markers showing increments, typically 5 mm, 1 cm, and 5 cm.

In one embodiment, a display system according to the invention comprises a display system that overlays, onto a display of a medical image, a grid with markers for increments of 5 mm, 1 cm, and 5 cm. The grid lines are displayed to be visible to the user without unduly obstructing the user's view of the underlying image. The grid can be displayed while the user works for ease in taking measurements. This display system would be particularly useful for follow-up studies of patients with cancer, for example, when interpreters measure multiple sites of disease. Making measurements at multiple sites using prevailing existing systems is a very laborious process. The process is far more convenient with a system according to the invention.

In one embodiment, a system according to the invention includes a feature called “magnified measure,” which involves the system providing a mechanism for measuring very small objects that require magnification of the diagnostic image in order for the user to obtain accurate measurements. Many diagnostic images include objects that measure on the order of just a few millimeters—unless these objects are magnified, they are difficult to measure accurately. It is for these small objects that “magnified measure” is especially advantageous.

Existing systems enable the user to measure diagnostic images under magnification, but those systems require the user to activate a magnification tool, then magnify the image, then activate a ruler, then click on several locations to place rulers, then take the measurement, then delete the rulers, then de-magnify the image. With existing systems, each step in this process requires the user to make selections and input them manually using a mouse or other input devices. In contrast, in one embodiment of the invention, other systems' multi-step input process is replaced with a single mouse click, which causes the system to display simultaneously several different degrees of magnification of the underlying image, with overlying rulers. In an example of a system according to the invention, the system offers the user the option to click one time and see two or more magnified displays of the diagnostic image with appropriately scaled rulers. The interpreter may then hold down the mouse button while taking the measurement visually using the most appropriate overlay, then release the mouse button. Thus a system according to the invention generally will be faster and easier for the user than existing systems.

To use the “magnified measure” feature, the interpreter identifies the relevant portion of the image by clicking on it with the mouse button. In response, the system displays the diagnostic image at a plurality of levels of magnification (preferably four levels), including the current level of magnification and three additional levels of magnification. This display may be provided by superimposing the magnified images upon the original image. In an embodiment with four levels of magnification, the levels of magnification may be adjusted but generally range from 1× (no magnification, original image) to 2×. Modifications and adjustments which have been made to the underlying image, such as rotation, inversion, translation, flipping horizontally and/or vertically, preferably are accounted for by maintaining the selected modifications and adjustments in each display provided by the system.

Preferably the system is adapted to operate on medical images using the Digital Imaging and Communications in Medicine (DICOM) standard for handling, storing, printing, and transmitting information in medical imaging. The system displays the images using tick marks or grid lines to provide a scale reference for making quick measurements. The tick marks/grid lines are set dynamically based on the total degree of magnification in each of the four panels. The underlying DICOM data set for the underlying image is accessed to calibrate the measurement tool and determine how many pixels there are per unit of measurement in the unmagnified data set as well as in each of the magnified panels. Screen resolution is taken into account in determining meaningful placement of tick marks and assignment of units of measurement to tick marks in each of the four panels, such that there are not too many tick marks on the display (which would make it difficult to read and difficult to view underlying image) or too few tick marks (which would not be as useful for measuring). Upon input by the user requesting more or fewer tick marks on the image, the image may be altered to cause more or fewer tick marks to be displayed. The system may blend overlying lines in with the underlying pixels to make it easier to perceive the image underlying the lines. As the user moves the mouse, the portion of the image subject to magnified measurement moves, following the hotspot of the mouse, such that the user may manipulate the chosen optimal magnification panel into optimum position for visually taking the measurement.

The overlying lines magnification tool is simpler than the magnified measurement tool and therefore lacks some of its features. But the overlying lines magnification tool does retain some or all of the following features: (a) the underlying magnification of the source image is taken into account in displaying the measurement grid or tick mark; (b) manipulations of the source image such as rotation, inversion, translation, flipping horizontally and/or vertically, are taken into account, and (c) calibration made with the DICOM spatial data set associated with the image to determine the calibrated location of minor & major tick marks, (d) screen resolution is taken into account to determine optimal placement of minor & major tick marks, and (e) overlying lines are blended in with the underlying pixels to make it easier to perceive the image beneath the lines.

Both of these methods allow the user to “stack” or “scroll” through the image set, applying the magnification and display operations selected by the user as detailed above to be applied to numerous images in succession within a series of diagnostic images. This amplifies the utility of the invention, allowing the labor saved in the measurement process to be applied not only to one image, but to a series of images within an image set, whereas previous methods would require laborious re-application of each step of the measurement process to each individual image. This may be of particular utility, for example, with regards to cancer staging and follow-up examinations, regarding which numerous measurements are often laboriously taken one after another on sequential images within an image set.

### BRIEF DESCRIPTION OF THE DRAWINGS

FIG. 1 is a diagram of the computer system according to an illustrative embodiment of the invention.

FIG. 2 is a screenshot of a single view of a medical image, as displayed by a system according to the invention.

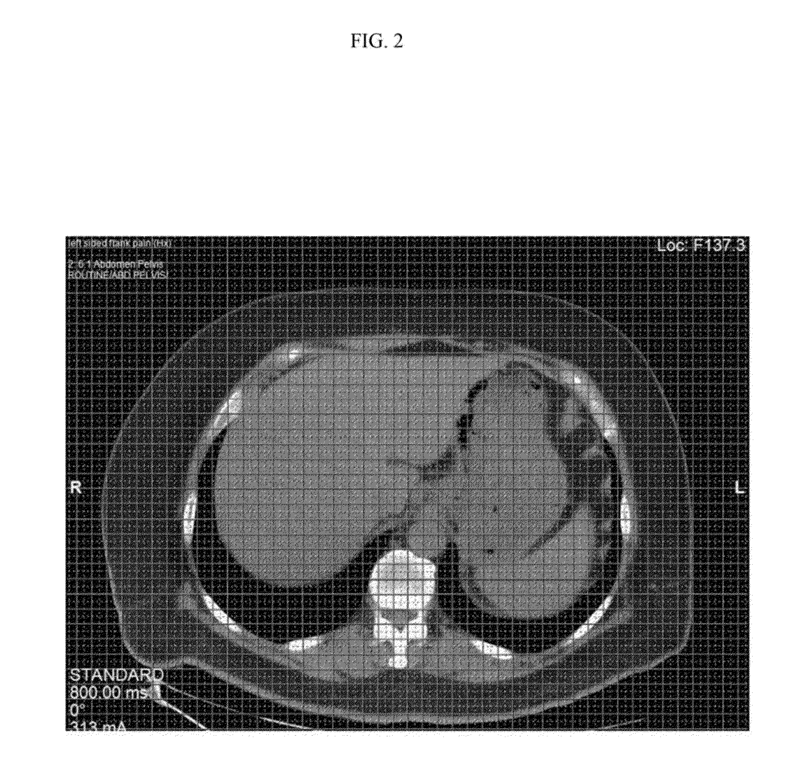

FIG. 3 is screenshot of four views of the same medical image shown in FIG. 2, as displayed by a system according to the invention.

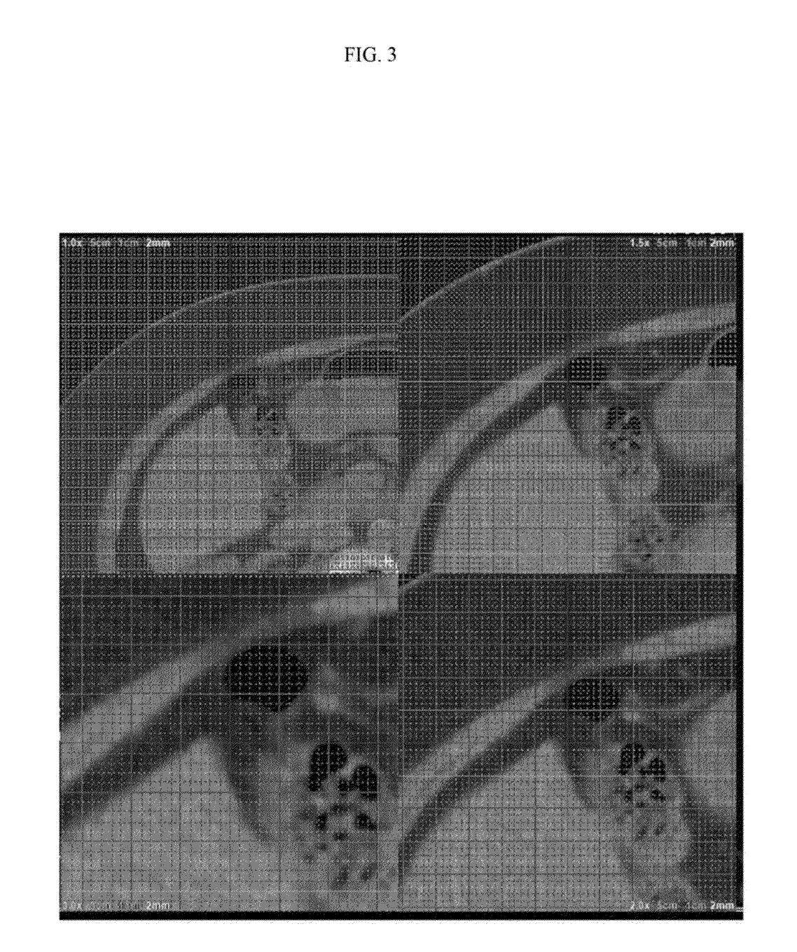

### DETAILED DESCRIPTION OF THE INVENTION

Following is a description of systems and methods according to illustrative embodiments of the invention.

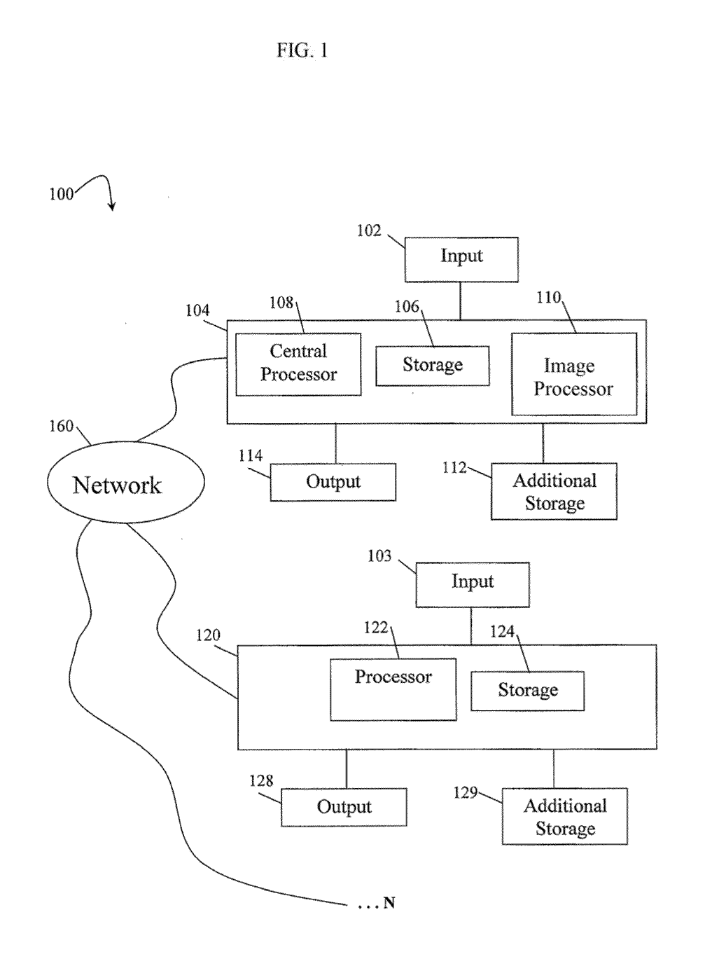

FIG. 1 depicts a diagnostic image review system 100 according to an illustrative embodiment of the invention. This schematic demonstrates a basic configuration of a diagnostic image review system 100, wherein a central server or cluster of servers manages multiple concurrent users of the diagnostic image review system via a network 160.

Diagnostic image review system 100 generally comprises a central computer 104, such as a server or server complex and one or more (N) local computers 120 connected over a network 160. Local computers 120 may be for example, workstations, image viewing stations, or individual computers. Central computer 104 processes and stores files of medical diagnostic images. Accordingly, central computer 104 includes at least one processor 108 and at least one image processor 110. Designated processors may be separate or a single processor having a plurality of functions. The image review processor 110 processes medical imaging data from the input 102 to be presented to the user via an output 114.

One or more input devices 102 input data and information into central computer 104. The input devices 102 may include for example a keyboard, touch screen, mouse, or joystick.

Central computer 104 is also functionally connected to one or more output devices 114. Output devices 114 may include for example, a display, projection, printer, or other device for displaying visual computer output, including medical images, overlaid words or markings, and text. Output devices 114 allow a user to view medical images, as modified by a system according to the invention.

Central computer 104 is depicted as having a storage component 106; however, one or more additional storage devices 112 may also be functionally connected to central computer 104. Such storage may include for example, random access memory (RAM) and read only memory (ROM) devices, CD-ROMs, flash memory, and various other storage disks. Other memory components may also be incorporated into the system to carry out the function of the computers.

Local computers 120 can be employed by users who are reviewing one or more medical images contained on central computer 104 or in storage accessible to central computer 104. Therefore, local computers 120 are depicted as having a processor 122 and storage 124. In a particular embodiment of the invention, the application of diagnostic measuring tools occurs on central computer 104, and only display of the image occurs at the local computers 120. In another embodiment, applications of the diagnostic measuring tools, as well as the display of images, are performed on the local computers 120. As with the central computer 104, the local computers 120 will have one or more input devices 103, one or more output devices 128, and may also have additional storage 129, illustrative types of which are described above.

Both the central computer 104 and local computers 120 may include an application program interface, for example a graphical user interface, for manipulating and displaying medical images and the diagnostic measuring tools.

Each computer described herein may stand alone to receive input data, to process data, to communicate with other computers or processors in the network, and to allow users to view various data.

Embodiments of the present invention may also be used with other computer systems such as a network of multiple processors and one or more storage units or a computer with a single processor and one or more storage units.

In the illustrative embodiment as shown in FIG. 1, the central computer 104 and local computer 120 may be embodied in one computer system or may be connected over a network 160 in a variety of configuration such as in parallel, in series or in a hub-and-spoke configuration. The computer network may include, for example, a local area network (LAN), a corporate network or an internetwork such as the Internet. In this illustrative embodiment, the computers are connected via a LAN such as an intranet within an organization. The network allows multiple users to work simultaneously on the multiple sets of medical imaging data within an organization. It may also be set up via the internet to allow multiple parties to input, to view, or to generate medical imaging study reports.

Both the central computer 104 and the local computers 120 may be central processing units (CPU), other centralized or main processors, graphics processing units (GPU), a set of computer-executable instructions, software applications for processing or one or more software applications for processing data relating to the generation of medical imaging study report, including any combination of the aforementioned processors.

It is noted that input imaging data may include but is not limited to data representing images generated by imaging technologies, such as ultrasound, computed tomography (CT), Computer Assisted Tomography (CAT), nuclear medicine, Positron Emission Tomography (PET) and magnetic resonance imaging (MRI). Images can also be captured from a modality such as for example an MRI scanner to a workstation over a network such as the Internet, local area network (LAN), wide area network (WAN) or other networks.

Described are exemplary steps for applying diagnostic measuring tools according to an illustrative embodiment of the invention. An image file is first made available to the system and is initially displayed for the user. Upon activation by the user, the system calculates the scale of image and overlays grid lines and/or tick marks at either standard intervals or at intervals selected by the user. Upon activation by the user, the system may also display the image in a plurality of views, each with a different magnification and with an appropriate set of grid lines or tick marks displayed thereon. The system optionally retains the magnification, rotation, and other characteristics of views of an image so that the same settings may be used to view the next image—this is very useful for images that are similar to previous images, such as consecutive views from a CT scan. Optionally, the system may save settings related to a set of views of an image for later application to image files—for example, the magnification and rotation of a particular image file may be saved for later use in reviewing later images of the same body part of the same patient. This is especially helpful for patients where ongoing studies of a particular site will be made—for example, patients with cancer.

Templates can be created for particular image studies for a particular body part, whether for patients generally or for a particular patient. These templates can include desired number of views, magnification, applicable grid lines and tick marks, image rotation, contract, etc.

The invention includes the methods as described herein, a computer readable medium programmed to carry out the methods, and a computer system configured to carry out the methods. The computer system includes a machine readable storage medium containing executable code; an apparatus having one or more processors; memory coupled to a processor; a machine-readable medium having machine-readable program code; an input device and an output device connected to the processor(s) to produce the reports or other material. While the invention is described by illustrative embodiments, additional advantages and modifications will occur to those skilled in the art. Therefore, the invention in its broader aspects is not limited to specific details shown and described herein.

Modifications, for example, to the type of reports and particular features of the software, may be made without departing from the spirit and scope of the invention. Accordingly, it is intended that the invention not be limited to the specific illustrative embodiments, but be interpreted within the full spirit and scope of the described embodiments and appended claims and their equivalents.

Claimed is:

1. A system for reviewing diagnostic images, comprising:
a processor;
a storage device operatively connected to the processor, the storage device capable of storing image data;
an output device operatively connected to the processor;
wherein the system operates upon a medical image stored in the storage device, the processor processes the image and displays a view of the image via the output device, and wherein the processing and displaying steps add to the view of the image a grid of markers displayed on said image at regular intervals.

2. A system for reviewing diagnostic images according to claim 1, further comprising:
an input device operatively connected to the processor;
wherein upon the input device receiving a selection of a medical image stored in the storage device, the processor processes the image and displays a view of the image via the output device, and wherein said processing and displaying steps add to the view of the image a grid of markers displayed on the view at regular intervals.

3. A computer system for reviewing medical images according to claim 1, wherein the processor processes a plurality of images in sequence and displays a view of each image in sequence via the output device, and where said processing and displaying steps add to the view of each image a grid of markers displayed on said view at regular intervals, the intervals being the same for each of the plurality of images.

4. A system for reviewing diagnostic images according to claim 1, wherein the processor processes an image and display a plurality of views of the image via the output device, with each view being displayed at a given scale and being displayed with a grid of markers adapted to the level of magnification involved in that particular view.

5. A system for reviewing diagnostic images according to claim 4, wherein the processor processes the image and displays a plurality of views in response to a single input by the user.

6. A system for reviewing diagnostic images according to claim 5, wherein each of the plurality of views of the image preserves any modifications to the image selected prior to user's input requesting the plurality of views.

7. A system for reviewing diagnostic images according to claim 5, wherein the plurality of views includes four views of the image.

8. A system for reviewing diagnostic images according to claim 6, wherein the system is capable of processing a plurality of images in sequence and displaying a view of each image in sequence via the output device, and wherein said processing and displaying steps add to the view of each image a grid of markers displayed on said view at regular intervals, the intervals being the same for each of the plurality of images.

9. A system for reviewing diagnostic images according to claim 8, wherein the system processes a plurality of images providing the same views and applying the same adjustments to each of said medical images.

10. A method for reviewing diagnostic images, comprising:
providing a system according to claim 1;
receiving a medical image for processing;
processing the image via the processor;
displaying a view of the image via the output device;
wherein the processing and displaying steps add to the view of the image a grid of markers displayed on said image at regular intervals.

11. A computer-readable medium containing instructions causing a computer system to carry out the methods claimed in claim 10.
